(19) United States
(12) Patent Application Publication
(10) Pub. No.: US 2022/0099871 A1
(43) Pub. Date: Mar. 31, 2022

(54) DIFFRACTIVE OPTICAL MEMBER AND VIRTUAL IMAGE DISPLAY DEVICE

(71) Applicant: SEIKO EPSON CORPORATION, Tokyo (JP)

(72) Inventors: Eiichi FUJII, Shiojiri-shi (JP); Atsushi SAITO, Chino-shi (JP)

(73) Assignee: SEIKO EPSON CORPORATION, Tokyo (JP)

(21) Appl. No.: 17/489,025

(22) Filed: Sep. 29, 2021

(30) Foreign Application Priority Data
Sep. 30, 2020 (JP) 2020-164392

(51) Int. Cl. G02B 5/18; G02B 27/01; G02B 27/42; G02B 5/32

(52) U.S. Cl. CPC G02B 5/1814; G02B 27/0172; G02B 2027/0174; G02B 5/32; G02B 2027/0178; G02B 27/4205

(57) ABSTRACT

A diffractive optical member includes: a hologram element, a substrate that supports the hologram element, a dielectric film that is provided between the hologram element and the substrate, a buffer layer that is formed around the hologram element so as to buffer a stress applied to the hologram element from outside of the hologram element, and an adhesive layer that makes the buffer layer and the dielectric film adhere to each other.

The present application is based on, and claims priority from JP Application Serial Number 2020-164392, filed Sep. 30, 2020, the disclosure of which is hereby incorporated by reference herein in its entirety.

### BACKGROUND

### 1. Technical Field

The present disclosure relates to a diffractive optical member applicable to guiding of a light in a virtual image display device that provides a viewer with a virtual image, and a virtual image display device including the diffractive optical member.

### 2. Related Art

As a diffractive optical member applicable to a virtual image display device, there has been disclosed a diffractive optical member where a dielectric film is disposed around a hologram element thus preventing the intrusion of moisture from outside (JP-A-2019-148738).

However, in the related art, in a case where the dielectric film is disposed around the hologram element via an adhesive layer, although the intrusion of moisture into the hologram element from outside can be prevented by the dielectric film, in forming the adhesive layer, an adhesive agent that is a material for forming the adhesive layer is cured and contracted and hence, a stress is applied to the hologram element thus giving rise to a possibility that the diffraction characteristic of the hologram element is changed.

### SUMMARY

A diffractive optical member according to an aspect of the present disclosure includes: a hologram element, a substrate that supports the hologram element, a dielectric film that is provided between the hologram element and the substrate, a buffer layer that is formed around the hologram element so as to buffer a stress applied to the hologram element from outside of the hologram element, and an adhesive layer that makes the buffer layer and the dielectric film adhere to each other.

### BRIEF DESCRIPTION OF THE DRAWINGS

FIG. 1 is a perspective view for explaining an external appearance of a head-mounted display including a diffractive optical member according to a first embodiment.

FIG. 2 is a ray diagram of an optical system in the head-mounted display.

FIG. 3 is a schematic longitudinal cross-sectional view of the diffractive optical member.

FIG. 4 is a graph for explaining diffraction characteristics of the diffractive optical member.

FIG. 5 is a schematic longitudinal cross-sectional view of a diffractive optical member according to a modified example of the first embodiment.

FIG. 6 is a schematic longitudinal cross-sectional view of a diffractive optical member according to a second embodiment.

FIG. 7 is a schematic longitudinal cross-sectional view of a diffractive optical member according to a third embodiment.

FIG. 8 is a schematic longitudinal cross-sectional view of a diffractive optical member according to a modified example of the third embodiment.

FIG. 9 is a schematic longitudinal cross-sectional view of a diffractive optical member according to a fourth embodiment.

FIG. 10 is a schematic longitudinal cross-sectional view of a diffractive optical member according to a modified example of the fourth embodiment.

FIG. 11 is a schematic longitudinal cross-sectional view of a diffractive optical member according to a fifth embodiment.

FIG. 12 is a schematic longitudinal cross-sectional view of a diffractive optical member according to a sixth embodiment.

FIG. 13 is a schematic longitudinal cross-sectional view of a diffractive optical member according to a modified example of the sixth embodiment.

FIG. 14 is a ray diagram of an optical system in a head-mounted display according to another example.

### DESCRIPTION OF EXEMPLARY EMBODIMENTS

### First Embodiment

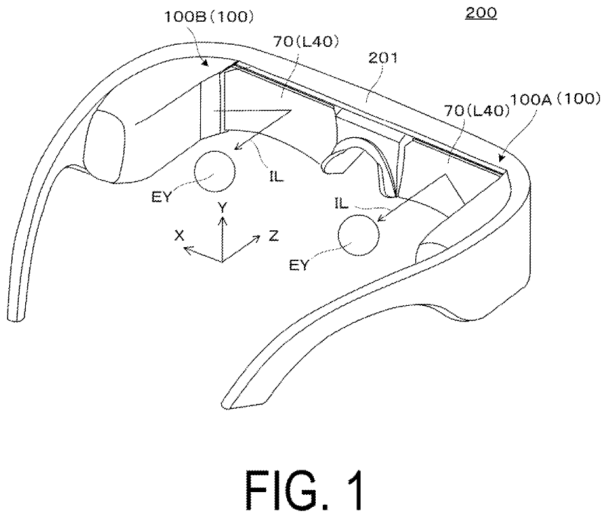

Hereinafter, a diffractive optical member and a head-mounted display as an example of a virtual image display device including the diffractive optical member according+ to one constitutional example of a present embodiment are described with reference to FIG. 1 and the like.

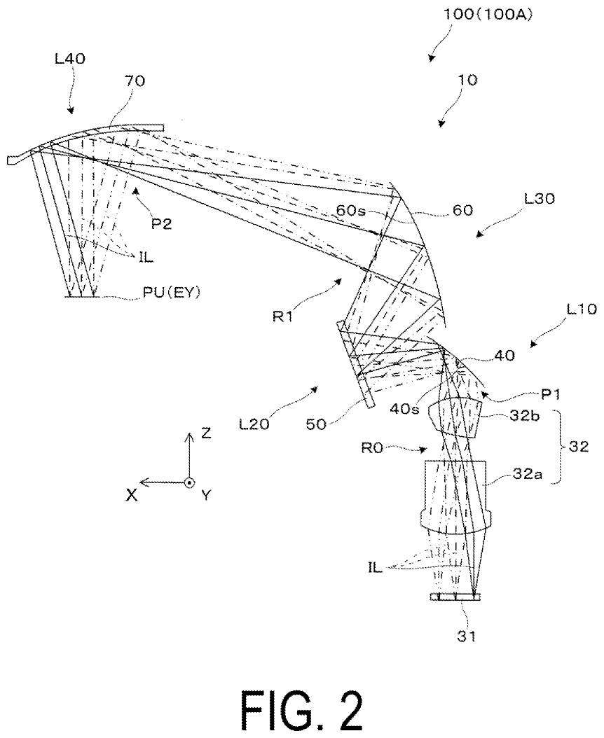

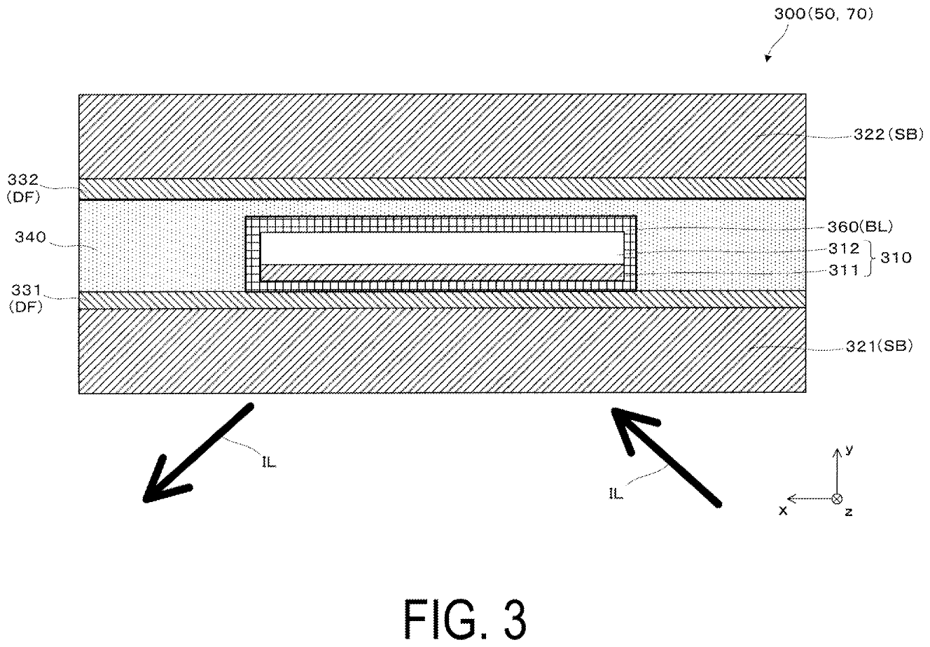

FIG. 1 is a perspective view illustrating an external appearance of a head-mounted display (hereinafter also referred to as HMD) 200 including a display device 100 as the virtual image display device, that is, an external appearance of a head mounting type display device according to one aspect of the present embodiment. FIG. 2 is a ray diagram of an optical system 10 in the display device 100. FIG. 3 is a schematic longitudinal cross-sectional view of the structure of a diffractive optical member 300 applied as diffractive optical member 50, 70 (see FIG. 2) that forms the optical system 10 of the display device 100. For example, in FIG. 3 and the like, to illustrate the respective layers and the respective members at the respective portions that form the diffractive optical member 300 such that readers of this specification can visually recognize the respective layers and the respective members at the respective portions that form the diffractive optical member 300, the respective layers and the respective members are illustrated differently from actual layers and actual members in thicknesses, ratios of the thicknesses and the like.

As illustrated in FIG. 1, the HMD 200 includes a display device 100A for the right eye, a display device 100B for the left eye, and a frame 201 that supports the display devices 100A and 100B. The display devices 100A and 100B are each formed of a see-through virtual image display device that is configured to generate an image light IL and to guide the generated image light IL to an area in front of the left or right eye EY of a viewer or a wearer thus making the image light IL viewable in a state where the image light IL is superposed on an image of an outside world. With such a configuration, it is possible to realize an Augmented Reality (AR) display where virtual visual information such as an image or data is added to, for example, an image of an outside world or an object to be observed in a superimposed manner.

In the HMD 200, the structure and the like of a second diffractive optical member 70 as a fourth optical part L40 disposed in front of the eye EY in order to extract an image light IL is described in detail later.

In FIG. 1 and the like, an axis X, an axis Y, and an axis Z form an orthogonal coordinate system, a +X direction corresponds to a lateral direction along which both eyes EY of a viewer or a wearer wearing the HMD 200 including the display device 100 are aligned, a +Y direction corresponds to an upward direction orthogonal to the lateral direction along which both eyes EY of a wearer US are aligned, and a +Z direction corresponds to a frontward direction of the wearer US or a front surface direction. In FIG. 1, not only the display device 100A for the right eye but also the display device 100B for the left eye is also illustrated. However, the display device 100A for the right eye and the display device 100B for the left eye are optically reversed in configuration in the lateral direction and hence, in the description made hereinafter, the display device 100A for the right eye is described as the representative display device 100. For example, FIG. 2 illustrates a ray diagram with respect to the optical system 10 in the display device 100A for the right eye.

Hereinafter, a constitutional example of the optical system 10 of the display device 100 is described with reference to the ray diagram illustrated in FIG. 2.

In an example illustrated in FIG. 2, the optical system 10 of the display device 100 includes an image light generating device 31, a projection optical system 32, a mirror 40, a first diffractive optical member 50 that is a reflection-type diffraction element, a mirror 60, and a second diffractive optical member 70 that is a reflection-type diffraction element in order from a light source side.

In the optical system 10, the image light generating device 31 includes a light source and generates an image light IL. As the image light generating device 31, for example, a display panel such as an organic EL display element or the like can be adopted. In this case, it is possible to provide the small-sized display device 100 capable of displaying a high-quality image. The image light generating device 31 may be configured to include an illumination light source (not illustrated) and a display panel such as a liquid crystal display element that modulates an illumination light emitted from the illumination light source. Further, the image light generating device 31 may be also configured to modulate laser light using a micro-mirror device. In the illustrated example, the image light generating device 31 is configured to include one display panel capable of color display. However, the image light generating device 31 may be constituted of a plurality of display panels corresponding to respective colors and a synthetic optical system that synthesizes image lights of respective colors from the plurality of display panels.

In the optical system 10, the projection optical system 32 includes a rotationally symmetrical lens 32a and a free form surface lens 32b, and is configured to project the image light IL emitted from the image light generating device 31 toward a post-stage of an optical path.

The mirror 40 has a reflective surface 40s that is formed of a concave curved surface, and has a positive power. The mirror 40 is disposed at a middle position in the optical path extending from the projection optical system 32 to the first diffractive optical member 50. The projection optical system 32 forms a first intermediate image P1 on or near a reflective surface of the mirror 40. With respect to the mirror 40, the mirror 40 may be considered as a constituent of the projection optical system 32.

The mirror 60 has a reflective surface 60s that is formed of a concave curved surface, and has a positive power. The reflective surface 60s is considered to be a spherical surface, an aspheric surface, or a free form surface, and in the present embodiment, the reflective surface 60s is formed of a free form surface. The mirror 60 reflects the image light IL diffracted by the first diffractive optical member 50 toward the second diffractive optical member 70. A second intermediate image P2 of the image light IL is formed between the mirror 60 and the second diffractive optical member 70 as the fourth optical part L40.

The first and second diffractive optical members 50, 70 are each formed of a reflection-type volume holographic element. Out of the first and second diffractive optical members 50, 70, the second diffractive optical member 70 has a concave curved surface and has a positive power. According to the present embodiment, in the first and second diffractive optical members 50, 70, by providing a buffer layer around the hologram element that is a body portion performing the diffraction, a stress applied to the hologram element from outside of the hologram element is buffered, and a state of diffraction is maintained in a desired state so that the image formation in the display device 100 is favorably maintained. The structure relating to the first diffractive optical member 50 or the second diffractive optical member 70 is described in detail later with reference to FIG. 3 and the like.

In the above-described configuration, it is also conceivable that the optical system 10 is constituted of, besides the image light generating device 31, a first optical part L10 constituted of the projection optical system 32 and the mirror 40, a second optical part L20 constituted of the reflection-type first diffractive optical member 50, a third optical part L30 constituted of the mirror 60, and the fourth optical part L40 constituted of the reflection-type second diffractive optical member 70. In the example of this embodiment, the second intermediate image P2 of the image light IL is formed between the third optical part L30 and the fourth optic part L40, that is, between the mirror 60 and the second diffractive optical member 70 and, further, the fourth optical part L40 (second diffractive optical member 70) collimates the image light thus forming an exit pupil PU. The exit pupil PU is at a position assumed as a position of the viewer's eye EY.

According to the optical system 10 having the above-described configuration, the optical path of the image light IL is described in more detail below. First, the image light generating device 31 emits the image light IL toward the first optical part L10 constituted of the projection optical system 32 and the like. Next, the first optical part L10 emits the image light IL incident on the projection optical system 32 toward the second optical part L20 constituted of the first diffractive optical member 50. An exit pupil R0 is formed between the rotationally symmetrical lens 32a constituting the projection optical system 32 and the free form surface lens 32b, and the intermediate image P1 is formed in front of or behind the reflective surface 40s of the mirror 40. Further, the reflection-type first diffractive optical member 50 emits the incident image light IL toward the third optical part L30, that is a light-guiding system and is constituted of the mirror 60. That is, the first diffractive optical member 50 bends the optical path of the image light IL due to diffraction action. The mirror 60 emits the incident image light IL toward the fourth optical part L40 constituted of the second diffractive optical member 70 at the reflective surface 60s. The second diffractive optical member 70 collimates the incident image light IL and emits the incident image light IL toward the eye EY of the viewer thus forming the exit pupil PU. That is, the viewer's eye EY is at the position of the exit pupil PU in the above-mentioned configuration and hence, respective rays of light that constitute the image light IL are imaged on a retina of the eye EY as a point thus allowing the viewer to visually recognize a virtual image by the image light IL. An exit pupil R1 is formed between the mirror 60 and the second diffractive optical member 70.

Hereinafter, an example of the structure of the first diffractive optical member 50 or the second diffractive optical member 70 is described with reference to FIG. 3. A longitudinal cross-sectional view schematically illustrated as FIG. 3 illustrates an example of the diffractive optical member 300 having the structure applicable as the first diffractive optical member 50 or the second diffractive optical member 70. In other words, FIG. 3 is a view as viewed in a normal direction of a cross section across each component that constitute the diffractive optical member 300. Hereinafter, as illustrated in the drawings, a lateral direction along which respective layers extend as viewed in cross sectional view is assumed as a ±x direction, a vertical direction along which the respective layers are aligned is assumed as a ±y direction, and the above-mentioned normal direction is assumed as a ±z direction. Among these directions, a −y side is assumed as a lower side, and a +y side is assumed as an upper side.

As illustrated in the drawings, the diffractive optical member 300 according to the present embodiment is configured by stacking a plurality of members in a layered manner in the +y direction. To be more specific, the diffractive optical member 300 includes a hologram element 310, a first substrate 321 and a second substrate 322 that support the hologram element 310, a first dielectric film 331 provided between the hologram element 310 and the first substrate 321 and a second dielectric film 332 provided between the hologram element 310 and the second substrate 322, a resin layer 360 as a buffer layer BL formed around the hologram element 310, and an adhesive layer 340. In the drawings, the resin layer 360 is provided on all four surfaces, that is, an upper surface, a lower surface, and both left and right side surfaces of the sheet-like hologram element 310. Further, FIG. 3 is a cross-sectional view of the diffractive optical member 300 and hence, the illustration of front and back surfaces (side surfaces on ±z sides) out of the periphery of the hologram element 310 is omitted. However, the resin layer 360 is also provided on these surfaces.

The hologram element 310 is constituted of a hologram layer 311 forming a body portion of the hologram element 310 that performs diffraction in the diffractive optical member 300, and a transparent film layer 312 forming a cover member that protects the surface of the hologram layer 311.

The hologram layer 311 is a layer provided as a layer that functions as a body portion of the hologram element 310 that deflects an incident light. For example, the hologram layer 311 is a layer where interference fringes are formed by applying interference exposure of an object light and a reference light onto a holographic photosensitive layer having sensitivity corresponding to a predetermined wavelength thus forming a volume hologram.

As a material for forming the transparent film layer 312, various materials having light transmissivity can be used, and the transparent film layer 312 forms a surface of the hologram element 310 while protecting the hologram layer 311 where the volume hologram is formed. For example, it is conceivable that polycarbonate, polyamide, TAC, or the like is used as the material for forming the transparent film layer 312.

The first substrate 321 and the second substrate 322 are each formed of a transparent substrate (light-transmissive substrate), and allow a visible light such as an image light and an external light to pass therethrough.

The first dielectric film 331 and the second dielectric film 332 are each formed of a material capable of imparting water vapor barrier property and transparency, and are configured to suppress and prevent the intrusion of moisture into the hologram element 310 by covering the upper surface (the other surface) and the lower surface (one surface) of the hologram element 310 with certainty. When moisture enters into the hologram layer 311, the volume hologram constituting the hologram layer 311 expands, and due to such an expansion of the volume hologram, positional deviation occurs in the interference fringes of the hologram layer 311 so that the deflection characteristic is deteriorated. On the other hand, in the present embodiment, the first dielectric film 331 and the second dielectric film 332 function as a water vapor barrier layer for suppressing or preventing the intrusion of moisture (water vapor) into the hologram element 310.

The adhesive layer 340 is formed of a material (adhesive agent) having transparency, and it is conceivable that an acrylic resin, a silicone resin, a polyester resin, a urethane resin, a polyvinyl acetate resin, or the like is used as the material for forming the adhesive layer 340, for example. It is also conceivable that, besides an ultraviolet curing resin, for example, a thermosetting resin is used as the material for forming the above-mentioned adhesive layer 340.

The resin layer 360 is formed of a material having a lower elastic modulus than the transparent film layer 312 that is a member forming the surface of the hologram element 310, and is a plastic or flexible low elastic modulus resin layer. More preferably, the elastic modulus of the low elastic modulus resin layer is equal to or less than 50 Mpa, for example. That is, the resin layer 360 has a property that the resin layer 360 is easily deformable, and is formed around the hologram element 310 and hence, the resin layer 360 functions as the buffer layer BL for buffering a stress applied to the hologram element 310 from outside of the hologram element 310 (in the present embodiment, a stress caused by contracting action when the adhesive layer 340 is formed by curing the adhesive agent). Further, the low elastic modulus resin layer, that is, the resin layer 360 can be formed using an ultraviolet curing resin, for example.

Hereinafter, the configuration of the diffractive optical member 300 constituted of the above-mentioned respective portions is described in more detail. As illustrated in the drawings and as described above, the diffractive optical member 300 is formed by stacking the above-mentioned respective portions that constitute the diffractive optical member 300 in a multilayered manner. To explain the respective portions in order from a lower side (−y side) specifically, first, the first dielectric film 331 is formed on the first substrate 321, and the hologram element 310 in a state surrounded by the resin layer 360 is fixedly mounted on the first dielectric film 331 in a state where the periphery of the hologram element 310 is surrounded by the adhesive layer 340. Further, the second dielectric film 332 is mounted on the adhesive layer 340, and the second substrate 322 is mounted on the second dielectric film 332. In other words, the hologram element 310 and the resin layer 360 containing the hologram element 310 are sandwiched between the first substrate 321 on which the first dielectric film 331 is formed and the second substrate 322 on which the second dielectric film 332 is formed, and is fixed (fixedly mounted) by the adhesive layer 340.

To summarize the configuration of the diffractive optical member 300 described above again from a different point of view, firstly, as a premise, the diffractive optical member 300 includes the hologram element 310 that functions as the body portion of the diffractive optical member 300 and the resin layer 360 as a protective layer that protects the hologram element 310 from an external stress (a stress applied to the hologram element 310 from outside of the hologram element 310). In addition, the diffractive optical member 300 includes the first substrate 321 and the second substrate 322 that sandwich the hologram element 310 therebetween as substrates SB supporting the hologram element 310. The diffractive optical member 300 includes, as dielectric films DF provided between the hologram element 310 and the substrates SB, the first dielectric film 331 provided between the hologram element 310 and the first substrate 321, and the second dielectric film 332 provided between the hologram element 310 and the second substrate 322. Further, the diffractive optical member 300 includes the adhesive layer 340 that makes the first dielectric film 331 and the second dielectric film 332 adhere to each other.

In the above-mentioned case, with respect to the hologram element 310, the hologram layer 311 is disposed facing the first dielectric film 331, and the transparent film layer is disposed facing the first dielectric film 331 with the hologram layer 311 interposed between the transparent film layer and the first dielectric film 331.

In addition, as illustrated in the drawings, as viewed in the normal direction (+z direction) of a cross section across each component, the resin layer 360 that forms the buffer layer BL is provided so as to surround the hologram element 310 that is formed by the hologram layer 311 and the transparent film layer 312 in layers.

In the diffractive optical member 300 having the above-mentioned configuration, for example, in a case where the image light IL is incident from the first substrate 321 that forms the lowermost layer, when the image light IL reaches the hologram layer 311 of the hologram element 310 through the respective portions on a lower layer side, the image light IL is diffracted in the hologram layer 311, and a component light as a diffracted light is emitted from the surface of the first substrate 321. As described above, the diffractive optical member 300 functions as a reflection-type diffraction element. That is, the diffractive optical member 300 is applicable as the first diffractive optical member 50 and the second diffractive optical member 70 illustrated with reference to FIG. 2.

Hereinafter, a specific manufacturing process of the diffractive optical member 300 is described. First, as a premise, assume that the first substrate 321 on which the first dielectric film 331 is formed and the second substrate 322 on which the second dielectric film 332 is formed are prepared by an existing technique such as sputtering, for example. In addition, with respect to the formation of the hologram element 310 and the resin layer 360, firstly, an ultraviolet curing resin scheduled to form the resin layer 360 is applied to the entire surface of a member scheduled to form the hologram layer 311 and the transparent film layer 312, that is, scheduled to form the hologram element 310 by coating, and an ultraviolet ray is irradiated to the ultraviolet curing resin. As a result, the ultraviolet curing resin is cured so that the resin layer 360 in a state of covering the hologram element 310 is formed. Next, the adhesive agent is cured by maintaining a state where the hologram element 310 covered by the resin layer 360 is sandwiched, together with the adhesive agent, between the first substrate 321 and the second substrate 322 that are prepared in a state where the above-mentioned first and second dielectric films 331, 332 are formed in advance on the first and second substrates 321, 322 respectively. By curing the adhesive agent, the adhesive layer 340 is formed, and the layered diffractive optical member 300 as illustrated in the drawing is formed. As described above, it is assumed that the ultraviolet curing resin or a thermosetting resin is used as the adhesive agent.

Here, in the configuration described above, the resin layer 360 has a low elastic modulus as described above and hence, the resin layer 360 plays a role of a cushion or a sponge between the hologram element 310 and the adhesive layer 340 upon the formation of the adhesive layer 340, that is, the contraction of the adhesive agent accompanying curing of the adhesive agent. That is, the resin layer 360 functions as the buffer layer BL that buffers a stress applied to the hologram element 310 from the adhesive layer 340 (from outside of the hologram element 310).

As described above, in the structure that the hologram element 310 is fixed by the adhesive layer 340, particularly, the diffraction in the hologram element 310 is adversely influenced by a stress due to curing and contraction of the adhesive agent accompanying the formation of the adhesive layer 340 and hence, there arises a drawback that the characteristic of the hologram element 310 is changed, and the diffraction efficiency is lowered. In order to cope with such a drawback, in the present embodiment, the resin layer 360 that functions as the buffer layer BL is provided as described above.

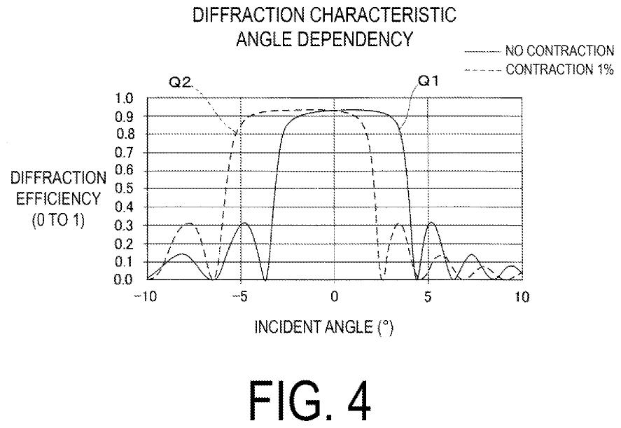

FIG. 4 is a graph for explaining an example of a diffraction characteristic (the angle dependency with respect to an incident angle of a light) in the diffractive optical member. In the graph, an incident angle (unit: °) of light with respect to the diffractive optical member is taken on an axis of abscissas, and the diffraction efficiency is taken on an axis of ordinates. The diffraction efficiency takes a value within a range of from 0 to 1. A curve Q1 indicates an example of the diffraction characteristic when the diffractive optical member is not contracted, and a curve Q2 indicates the diffraction characteristic of the diffractive optical member when the hologram layer 311 is contracted by 1% due to contracting action caused during adhesion or the like from a state of the diffractive optical member indicated by the curve Q1, for example.

As shown in the graph of FIG. 4, it can be understood that the curve Q1 shows the diffraction characteristic that is a left and right symmetry with respect to an angle 0°, while the curve Q2 is largely shifted from the curve Q1 so that the diffraction characteristic is changed. That is, when the hologram element 310 is deformed by being influenced by curing, contraction, or the like of the adhesive agent accompanying the formation of the adhesive layer 340, the hologram element 310 is shifted from a state of having the desired characteristic, and the diffraction efficiency is lowered. It is conceivable that such lowering of the diffraction efficiency is caused by a phenomenon that a fringe pattern formed on the hologram layer 311 that is the body portion of the hologram element 310 is deformed due to a stress applied from the adhesive layer 340 (the angle is changed).

To the contrary, in the present embodiment, as described above, by providing the resin layer 360 as the buffer layer BL between the adhesive layer 340 and the hologram element 310, it is possible to avoid or suppress the above-mentioned situation brought about by an influence of a stress in the adhesive layer 340. Accordingly, for example, when the diffractive optical member 300 is applied to the first diffractive optical member 50 and the second diffractive optical member 70 constituting the HMD 200 as a virtual image display device as described above, a favorable image formation can be realized in the HMD 200.

As described above, the diffractive optical member 300 according to the present embodiment includes the hologram element 310, the substrates 321, 322 that support the hologram element 310, the dielectric film 331 provided between the hologram element 310 and the substrate 321 and the dielectric film 332 provided between the hologram element 310 and the substrate 322, the buffer layer BL that is formed around the hologram element 310 and buffers a stress applied to the hologram element 310 from outside of the hologram element 310, and the adhesive layer 340 that makes the buffer layer BL and the dielectric films 331, 332 adhere to each other.

According to the above-mentioned diffractive optical member 300, it is possible to avoid or suppress that the diffraction in the hologram element 310 is adversely influenced by a stress caused by curing and contraction accompanying the formation of the adhesive layer 340 and hence, when the diffractive optical member 300 is applied to the HMD 200 that is a virtual image display device, for example, favorable image formation can be realized.

In the respective constituents of the diffractive optical member 300 described above, as a material for forming the first and second substrates 321, 322, for example, a resin material such as polyethylene terephthalate, polyethylene naphthalate, polypropylene, cycloolefin polymer, polyamide, polyether sulfone, polymethyl methacrylate, polycarbonate, and polyarylate, a glass material such as quartz glass and soda glass, and the like are conceivable. One kind or two or more kinds of these materials may be used in combination. An average thickness of the first and second substrates 321, 322 described above is not particularly limited. However, it is preferred that the average thickness be set to a value ranging from approximately 0.5 mm to 5 mm inclusive, and more preferably be set to a value ranging from approximately 0.7 mm to 2 mm inclusive.

As the material for forming the first and second dielectric films 331, 332, a material having dielectric property and capable of imparting water vapor barrier property and transparency to the first dielectric film 331 is available. As such a material, for example, besides an inorganic material such as a ceramic material and a glass material, a resin material and the like are conceivable. As the ceramic material, for example, alumina, zirconia, magnesia, silica, silicon monoxide, titania, hafnium oxide, aluminum nitride, silicon nitride, silicon carbide, and barium titanate, and the like are applicable, and one kind or two or more kinds of these materials may be used in combination. Of those, silicon monoxide (SiO), silica (SiO₂), alumina (Al₂O₃), hafnium oxide (HfO₂), zirconia (ZrO₂), and titania (TiO₂) are preferred. Further, when the ceramic material is used as the material for forming the dielectric films 331, 332, the first and second dielectric films 331, 332 can be formed relatively easily using a vacuum evaporation method, a sputtering method, an ion plating method, and a vapor-phase growth method such as a plasma chemical vapor-phase growth method. As the glass material, for example, quartz glass, borosilicate glass and the like are applicable. Further, as the resin material, for example, polyvinyl chloride, polyethylene, polypropylene, polytetrafluoroethylene, polyethylene terephthalate, polyvinyl fluoride, an epoxy resin, a phenol resin, and the like are applicable. Further, the first and second dielectric films 331, 332 may be formed of a single layer body or a multilayer body formed of the above-mentioned constituent materials, but it is preferred that the first and second dielectric films 331, 332 be a multilayer body. For example, in a case of using a multilayer body, for example, the first dielectric film 331 may be formed of a multilayer body that includes a layer formed of silicon monoxide (SiO) and a layer formed of alumina (Al₂O₃) in a state where the layer formed of silicon monoxide (SiO) is disposed on a first substrate 321 side, or a multilayer body that includes a layer formed of silicon monoxide (SiO) and a layer formed of hafnium oxide (HfO₂) in a state where the layer formed of silicon monoxide (SiO) is disposed on a first substrate 321 side. An average thickness of the first and second dielectric films 331, 332 is not particularly limited, but it is preferred that the thickness be set to a value ranging from approximately 50 nm to 1 μm inclusive for maintaining sufficient water vapor barrier property and for avoiding occurrence of film crack, and more preferably be set to a value ranging from approximately 100 nm to 300 nm inclusive.

In the above-mentioned configuration, to display an image on a retina of an eye EY of a wearer (viewer) in the HMD 200, in applying the diffractive optical member 300 to the HMD200, a mode is adopted where an incident image light IL is deflected (reflected) in the hologram element 310. However, the hologram element 310 can change (deflect) the direction of a light not only in a regular reflection direction but also in various directions. That is, in guiding a light in the HMD 200, the hologram element 310 and, eventually, the diffractive optical member 300 is applicable in order to change the direction of a light in various directions.

Further, a wavelength band where a light is deflected (reflected) and a wavelength band where a light is not deflected (reflected) (wavelength band that allows the transmission of a light) are determined by adjusting the characteristics of the hologram element 310. Accordingly, for example, when the diffractive optical member 300 is applied to the second diffractive optical member 70 (see FIG. 1 or FIG. 2), the HMD 200 can ensure the favorable see-through property while allowing the wearer (viewer) to visually recognize an image light with certainty.

Further, in the above-mentioned configuration, the first dielectric film 331 is provided between the first substrate 321 and the hologram element 310, that is, on a lower surface side of the hologram element 310, and exhibits a function as a water vapor barrier layer for suppressing or preventing the intrusion of moisture from the lower surface side of the hologram element 310. In the same manner, the second dielectric film 332 is provided between the second substrate 322 and the hologram element 310, that is, on an upper surface side of the hologram element 310, and exhibits a function as a water vapor barrier layer for suppressing or preventing the intrusion of moisture from the upper surface side of the hologram element 310. Here, in a cross-sectional view of FIG. 3, for example, a configuration on side surface sides (±x sides) is not mentioned. With respect to the side surface portions, it is conceivable to suppress or prevent the intrusion of moisture by providing a separate member, for example. An example of such a configuration is described later in other embodiments.

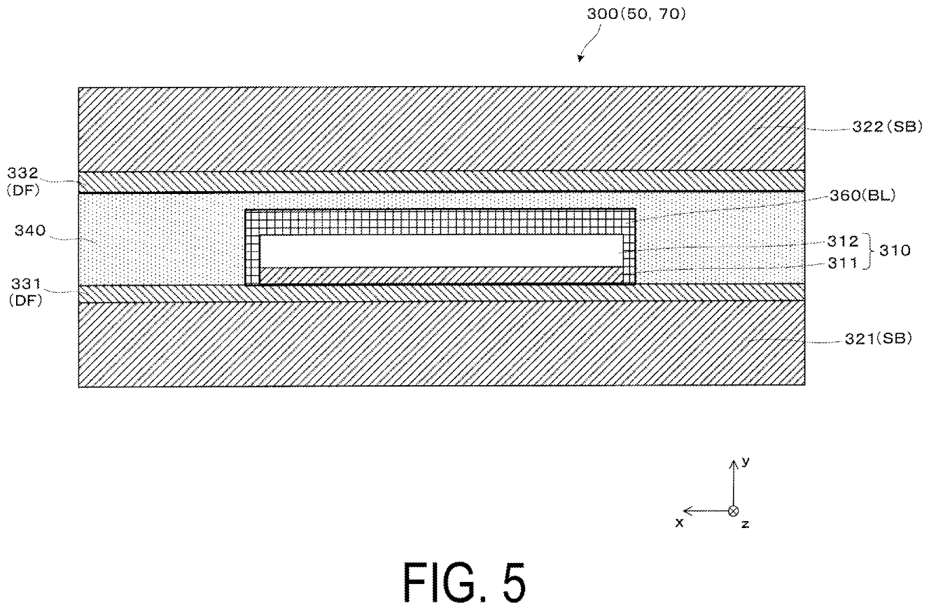

Hereinafter, one modified example of the diffractive optical member 300 is described with reference to FIG. 5. FIG. 5 is a longitudinal cross-sectional view corresponding to FIG. 3.

In the example illustrated in FIG. 3, the hologram element 310 is entirely covered by the resin layer 360 from the periphery of the hologram element 310. That is, in the sheet-like hologram element 310, the resin layer 360 is provided on all four surfaces, that is, the upper surface, the lower surface, and both left and right side surfaces of the hologram element 310 (the same goes also for the front and back surfaces of the hologram element 310 that are not illustrated). To the contrary, this modified example differs from the above-mentioned example with respect to a point that a hologram element 310 is not entirely covered by a resin layer 360. Specifically, as illustrated in FIG. 5, as viewed in cross sectional view, three surfaces of the hologram element 310 excluding a lower surface, that is, an upper surface and both side surfaces of the hologram element 310 are covered by a resin layer 360, and the hologram element 310 is bonded and fixed by an adhesive layer 340 in a state where the lower surface of the hologram element 310, that is, a surface of a hologram layer 311 is brought into contact with a first dielectric film 331 and in a state where other surfaces of the hologram element 310 are covered by the resin layer 360. Also in this case, by providing the resin layer 360, the diffractive optical member 300 can avoid or suppress that the diffraction in the hologram element 310 is adversely influenced by a stress of the adhesive layer 340. From a different perspective with respect to the above-mentioned configuration, the resin layer 360 is provided on at least three surfaces of the hologram element 310 and hence, the resin layer 360 functions as a buffer layer BL that buffers a stress applied to the hologram element 310 from the adhesive layer 340.

### Second Embodiment

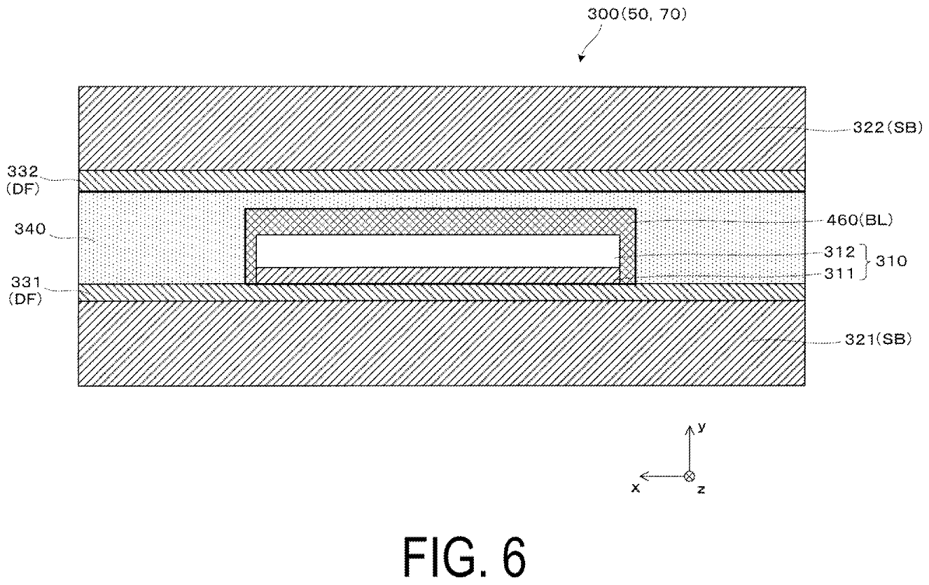

Hereinafter, an example of a diffractive optical member according to a second embodiment is described with reference to FIG. 6. A diffractive optical member 300 of the present embodiment is substantially equal to the diffractive optical member 300 of the first embodiment except for a configuration of a buffer layer BL, and is also applicable to the virtual image display device in the same manner as the first embodiment and hence, constituent elements of the diffractive optical member 300 according to the present embodiment are given the same symbols as the first embodiment, and are described with reference to the corresponding description in the first embodiment when necessary. FIG. 6 is a longitudinal cross-sectional view corresponding to FIG. 5.

The diffractive optical member 300 according to the present embodiment differs from the diffractive optical member 300 of the first embodiment with respect to a point that a water repellent layer 460 is applied as a buffer layer BL. That is, in the present embodiment, by covering a hologram element 310 by the water repellent layer 460, it is possible to avoid or suppress that the diffraction in the hologram element 310 is adversely influenced by a stress of an adhesive layer 340. In the example illustrated in FIG. 6, in the same manner as the case illustrated in FIG. 5, a configuration is illustrated where three surfaces of the hologram element 310 except for a lower surface, that is, an upper surface and both side surfaces of the hologram element 310 are covered by the water repellent layer 460 as the buffer layer BL. It is also conceivable that the water repellent layer 460 also covers the lower surface of the hologram element 310 in addition to the above-mentioned three surfaces of the hologram element 310.

Here, as a material for forming the water repellent layer 460, various materials are conceivable. Typically, it is conceivable that the water repellent layer 460 is formed of a fluorine-based material, for example. More specifically, it is conceivable that a material including a fluorine-based silane coupling agent is used as the material for forming the water repellent layer 460, for example. It is also conceivable that a water repellent treatment is applied to the upper surface and the side surfaces of the hologram element 310 using a fluorine-based gas. In this case, a frictional force between the formed water repellent layer 460 and the adhesive layer 340 is reduced and hence, a stress from the adhesive layer 340 is not transferred or minimally transferred to the water repellent layer 460 and, eventually, the hologram element 310 and hence, it is possible to avoid or suppress that the diffraction in the hologram element 310 is adversely influenced by the stress of the adhesive layer 340.

### Third Embodiment

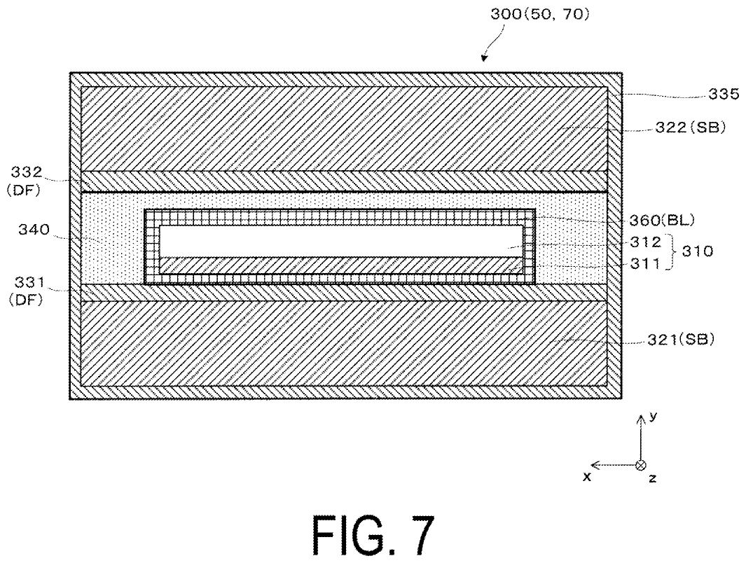

Hereinafter, an example of a diffractive optical member according to a third embodiment is described with reference to FIG. 7 and the like. A diffractive optical member 300 of the present embodiment differs from the diffractive optical members of other embodiments described above with respect to a point that the diffractive optical member 300 of the present embodiment includes an outer surface dielectric film OD provided on outer surfaces of first and second substrates 321, 322 that form substrates SB. However, other configurations of the diffractive optical member 300 of the present embodiment are substantially equal to the corresponding configurations of the diffractive optical member 300 of the first embodiment and the like, and the diffractive optical member 300 of the present embodiment is also applicable to the virtual image display device in the same manner as the first embodiment and the like and hence, constituent elements of the diffractive optical member 300 of the present embodiment are given the same symbols as the first embodiment, and are described with reference to the corresponding description in the first embodiment when necessary. FIG. 7 is a longitudinal cross-sectional view corresponding to FIG. 3 and the like.

The diffractive optical member 300 according to the present embodiment differs from the diffractive optical member 300 according to the first embodiment with respect to a point that an outer surface dielectric film 335 is provided on the outer surfaces of the first and second substrates 321, 322. In particular, in the example illustrated in FIG. 7, not only the first and second substrates 321, 322 but also the entire stacked body sandwiched between the first and second substrates 321, 322 is covered by the outer surface dielectric film 335.

As the outer surface dielectric film 335, it is conceivable to adopt an outer surface dielectric film that functions as a water vapor barrier layer in the same manner as the first dielectric film 331 and the like, for example. However, the outer surface dielectric film 335 may have a function as an antireflection film (AR coat) besides the above-mentioned function. From a different perspective, the antireflection film may have a function as the water vapor barrier layer.

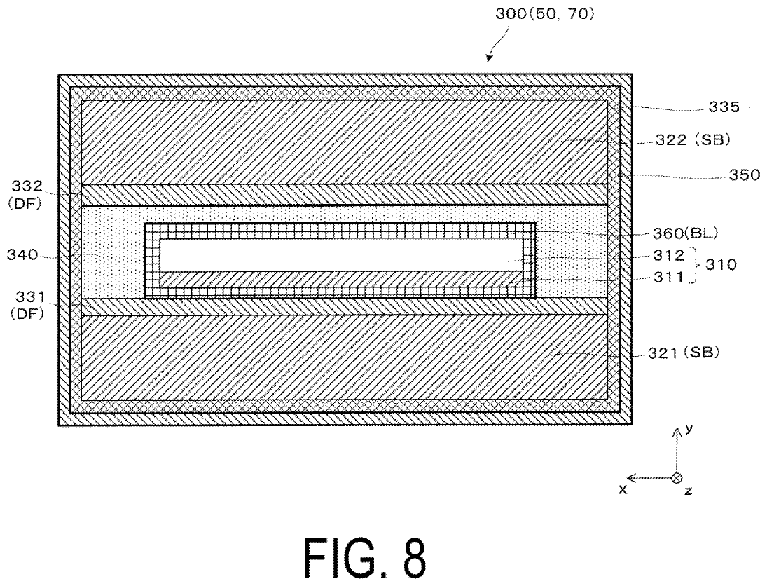

Further, as in the case of a modified example illustrated in FIG. 8, the diffractive optical member 300 may further include a hard coat layer 350 provided on an inner surface of the outer surface dielectric film 335. Here, the hard coat layer 350 can be formed of a hard coat layer that is formed using a composition containing an organic silicon compound (silane coupling agent) and a metallic oxide, for example.

### Fourth Embodiment

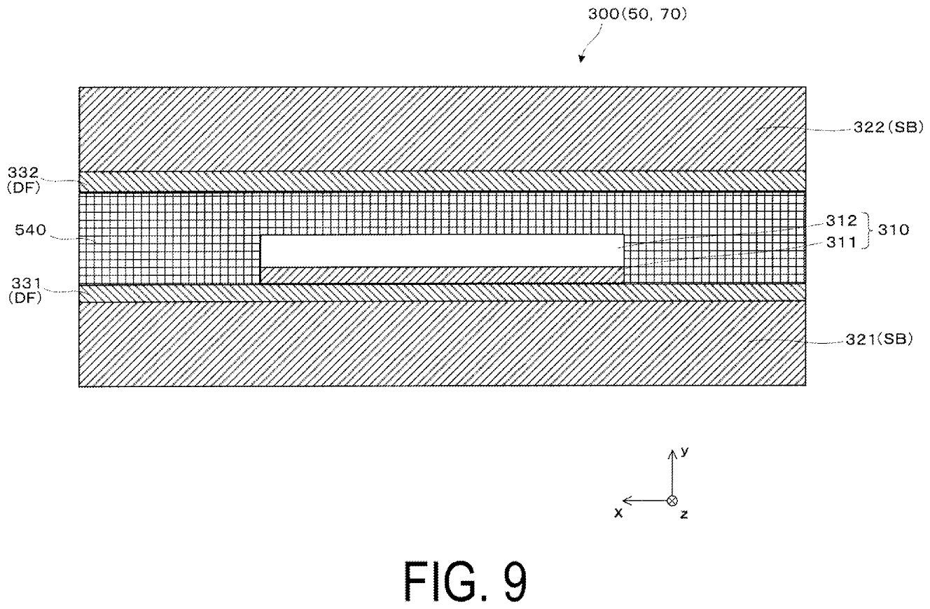

Hereinafter, an example of a diffractive optical member according to a fourth embodiment is described with reference to FIG. 9 and the like. A diffractive optical member 300 of the present embodiment differs from the diffractive optical members of other embodiments described above with respect to a point that an adhesive layer 540 is formed of a material having the lower elastic modulus than a transparent film layer 312 that is a member forming a surface of a hologram element 310, and a buffer layer BL is omitted. However, other configurations of the diffractive optical member 300 of the present embodiment are substantially equal to the corresponding configurations of the diffractive optical member 300 of the first embodiment and the like, and the diffractive optical member 300 of the present embodiment is also applicable to the virtual image display device in the same manner as the first embodiment and the like and hence, constituent elements of the diffractive optical member 300 of the present embodiment are given the same symbols as the first embodiment, and are described with reference to the corresponding description in the first embodiment when necessary. FIG. 9 is a longitudinal cross-sectional view corresponding to FIG. 3 and the like.

The diffractive optical member 300 according to the present embodiment includes the hologram element 310, and a first substrate 321 and a second substrate 322 that sandwich the hologram element 310 therebetween as substrates SB supporting the hologram element 310. Further, the diffractive optical member 300 includes, as a dielectric film DF provided between the hologram element 310 and the substrate SB, a first dielectric film 331 provided between the hologram element 310 and the first substrate 321, and a second dielectric film 332 provided between the hologram element 310 and the second substrate 322. The hologram element 310 is constituted of a hologram layer 311 forming a body portion of the hologram element 310 that performs the diffraction, and the transparent film layer 312 forming a cover member that protects a surface of the hologram layer 311. Further, the diffractive optical member 300 includes the adhesive layer 540 that makes the hologram element 310, the first dielectric film 331, and the second dielectric film 332 adhere to each other in a state where the hologram element 310 is sandwiched between the first dielectric film 331 and the second dielectric film 332. That is, the adhesive layer 540 makes the hologram element 310 and the dielectric films FD adhere to each other.

Here, the adhesive layer 540 is a low elastic modulus adhesive layer formed of a material having the lower elastic modulus than the transparent film layer 312 that is a member forming the surface of the hologram element 310. Since the adhesive layer 540 is the low elastic modulus adhesive layer, the influence of a stress generated by curing and contraction accompanying the formation of the adhesive layer 540 on the hologram element 310 can be sufficiently reduced. That is, also in the present embodiment, it is possible to avoid or suppress that the diffraction in the hologram element 310 is adversely influenced by a stress caused by curing and contraction accompanying the formation of the adhesive layer 540, and when the diffractive optical member 300 of the present embodiment is applied to the virtual image display device, for example, favorable image formation can be realized.

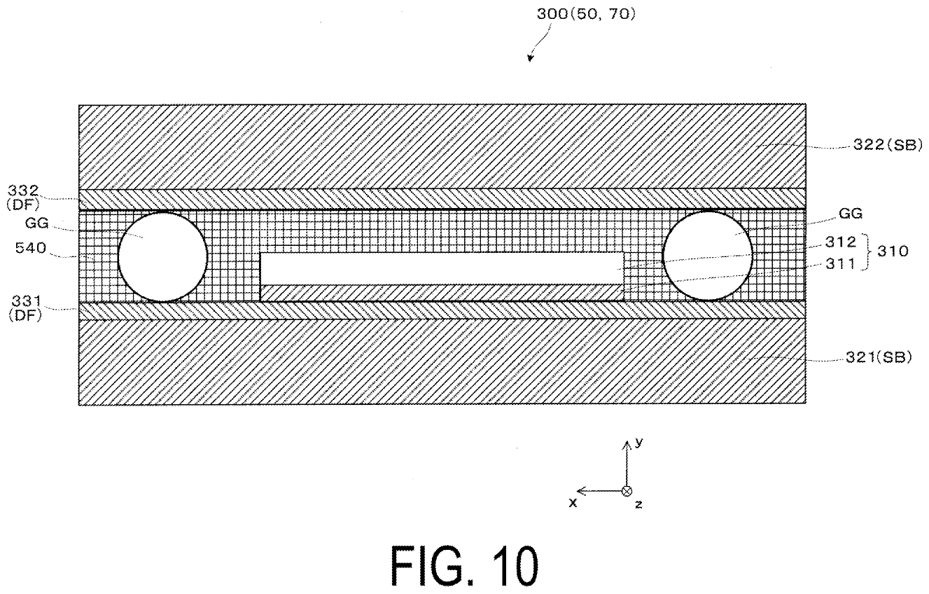

Further, as in the case of a modified example illustrated in FIG. 10, the diffractive optical member 300 may further include gap members GG included in the adhesive layer 540 serving as the low elastic modulus adhesive layer in addition to the configuration illustrated in FIG. 9. The gap members GG are each formed of a bead-like member or the like, for example. Since the gap members GG having a hardness equal to or above a certain degree are contained in the adhesive layer 540 that is the low elastic modulus adhesive layer, that is, the easily deformable adhesive layer 540, for example, it is possible to avoid that the hologram element 310 sandwiched between the first substrate 321 and the second substrate 322 is pressed and collapsed together with the adhesive layer 540 due to pressing by the first and second substrates 321, 322.

### Fifth Exemplary Embodiment

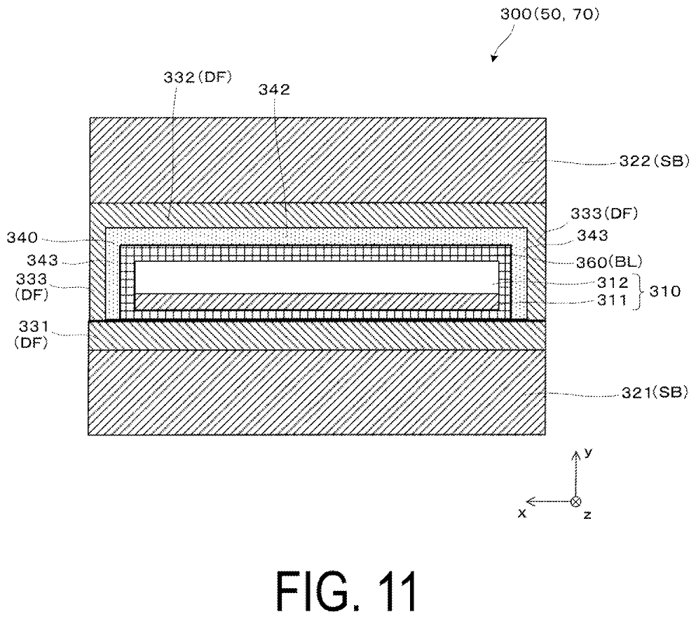

Hereinafter, an example of a diffractive optical member according to a fifth embodiment is described with reference to FIG. 11 and the like. A diffractive optical member 300 of the present embodiment differs from the diffractive optical members of other embodiments described above with respect to a point that the diffractive optical member 300 of the present embodiment further includes, as a dielectric film DF provided between a hologram element 310 and substrates SB, a third dielectric film 333 in addition to a first dielectric film 331 and a second dielectric film 332. However, other configurations of the diffractive optical member 300 of the present embodiment are substantially equal to the corresponding configurations of the diffractive optical member 300 of the first embodiment and the like, and the diffractive optical member 300 of the present embodiment is also applicable to the virtual image display device in the same manner as the first embodiment and the like and hence, constituent elements of the diffractive optical member 300 of the present embodiment are given the same symbols as the first embodiment, and are described with reference to the corresponding description in the first embodiment when necessary. FIG. 11 is a longitudinal cross-sectional view corresponding to FIG. 3 and the like.

The diffractive optical member 300 according to the present embodiment includes the first dielectric film 331 and the second dielectric film 332 as the dielectric films DF in the same manner as the example illustrated in FIG. 3. That is, the first dielectric film 331 is provided on a lower surface side (−y side) of the hologram element 310, while the second dielectric film 332 is provided on an upper surface side (+y side) of the hologram element 310. In addition to the first and second dielectric films 331, 332, the third dielectric film 333 is provided integrally with the second dielectric film 332 so as to extend in the −y direction at both ends (ends on ±x side) of the second dielectric film 332. That is, the third dielectric film 333 that forms the dielectric film DF is provided along side surfaces of the hologram element 310. That is, in this case, as viewed in cross sectional view, the dielectric films DF, that is, the first to third dielectric films 331 to 333 are in a state where the first to third dielectric films 331 to 333 cover the entire hologram element 310 including the adhesive layer 340.

On the other hand, the hologram element 310 is constituted of a hologram layer 311 forming a body portion of the hologram element 310 that performs the diffraction, and a transparent film layer 312 forming a cover member that protects a surface of the hologram layer 311. In the case illustrated in FIG. 11, that is, as viewed in cross sectional view, all surfaces of the hologram layer 311, that is, an upper surface, a lower surface, and both side surfaces of the hologram layer 311 are covered by a resin layer 360 that forms the buffer layer BL. The resin layer 360 is provided on at least three or more surfaces of the hologram element 310, and is disposed facing the first dielectric film 331, the second dielectric film 332, and the third dielectric film 333. In the example illustrated in FIG. 11, out of respective surfaces of the resin layer 360, the three surfaces other than the lower surface, that is, an upper surface and both side surfaces (two kinds of surfaces) face the dielectric films DF with the adhesive layer 340 interposed therebetween.

In the present embodiment, it is also conceivable that the adhesive layer 340 has an upper surface adhesive layer portion 342 that makes the upper surface of the hologram layer 311 and the second dielectric film 332 adhere to each other, and a side surface adhesive layer portion 343 that makes the side surfaces of the hologram layer 311 and the third dielectric film 333 adhere to each other. Also in the present embodiment, by providing the resin layer 360, it is possible to avoid or suppress that the diffraction in the hologram element 310 is adversely influenced by a stress caused by curing and contraction accompanying the formation of the adhesive layer 340, and when the diffractive optical member 300 of the present embodiment is applied to the virtual image display device, for example, favorable image formation can be realized.

### Sixth Exemplary Embodiment

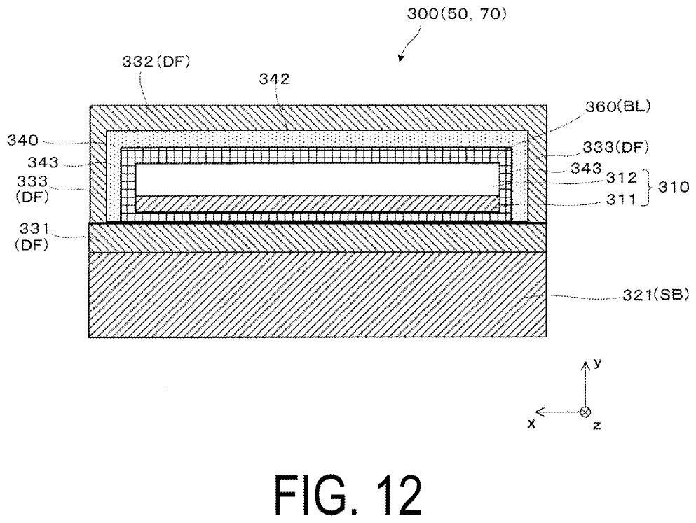

Hereinafter, an example of a diffractive optical member according to a sixth embodiment is described with reference to FIG. 12 and the like. A diffractive optical member 300 according to the present embodiment differs from the diffractive optical members 300 according to other embodiments described above with respect to a point that a substrate SB is constituted of only a first substrate 321. In the present embodiment, a configuration is exemplified as a modified example of the configuration illustrated in FIG. 11 in the fifth embodiment. Here, the structure other than the point described above is substantially equal to the corresponding structures of the fifth embodiment and the like, and the diffractive optical member 300 of the present embodiment is also applicable to the virtual image display device in the same manner as the fifth embodiment and the like and hence, constituent elements of the diffractive optical member 300 according to the present embodiment are given the same symbols as other embodiments, and are described with reference to the corresponding descriptions in other embodiments when necessary. FIG. 12 is a longitudinal cross-sectional view corresponding to FIG. 3, FIG. 11, and the like.

As described with reference to FIG. 12, the diffractive optical member 300 according to the present embodiment does not include a member corresponding to the second substrate 322 compared with the configurations illustrated in FIG. 3 and FIG. 11. Specifically, the diffractive optical member 300 includes a hologram element 310, and the first substrate 321 that sandwiches the hologram element 310 as the substrate SB supporting the hologram element 310.

With respect to the manufacture of the diffractive optical member 300 having the above-mentioned configuration, for example, it is conceivable to adopt a method where, in a state where a hologram layer 311 covered by a resin layer 360 is placed on the first substrate 321 on which a first dielectric film 331 is formed in advance, an adhesive agent scheduled to form an adhesive layer 340 is applied by coating, and the adhesive agent is cured to form the adhesive layer 340. Then, a second dielectric film 332 and a third dielectric film 333 are formed on the surface of the adhesive layer 340 thus manufacturing the diffractive optical member 300 having the configuration as illustrated in the drawing.

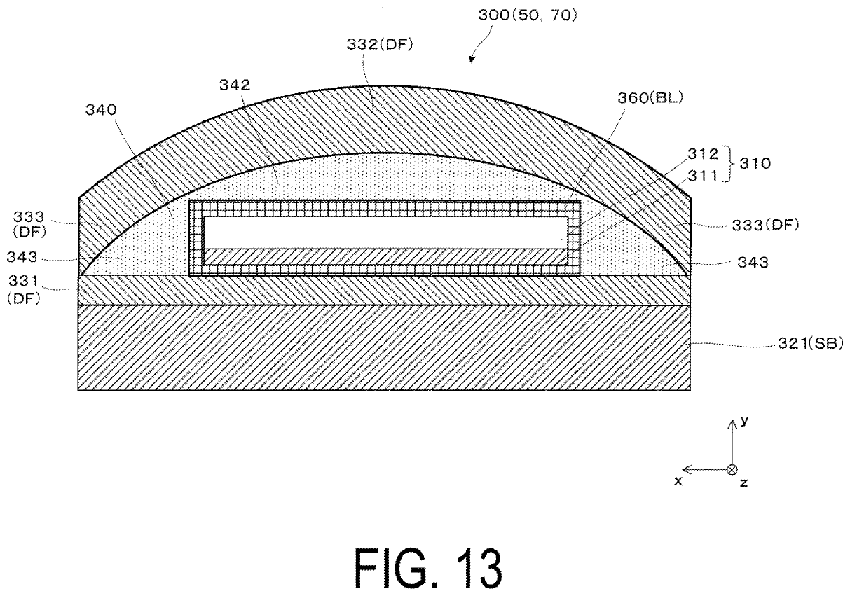

Further, as in the case of a modified example illustrated in FIG. 13, a diffractive optical member 300 may be configured such that an upper surface adhesive layer portion 342 and a side surface adhesive layer portion 343 that are integrally formed with each other as an adhesive layer 340 each have a thickness thereof gradually decreased in a direction from a center portion side toward an edge portion side, and a second dielectric film 332 and a third dielectric film 333 are integrally formed with each other corresponding to the adhesive layer 340 thus being formed in a curved shape. In this case, in manufacturing the diffractive optical member 300, after the adhesive layer 340 is formed in the above-mentioned shape by curing the adhesive agent, by using the vapor-phase growth method, for example, the second dielectric film 332 and the third dielectric film 333 can be formed relatively easily.

### Modified Examples and Other Matters

The specific structure of the diffractive optical member 300 described above, and the specific structures of the display device 100 and the HMD 200 to which the diffractive optical member 300 is applied are merely described in an exemplifying purpose, and various modifications are conceivable within a scope where substantially the same functions as the above-mentioned functions can be achieved.

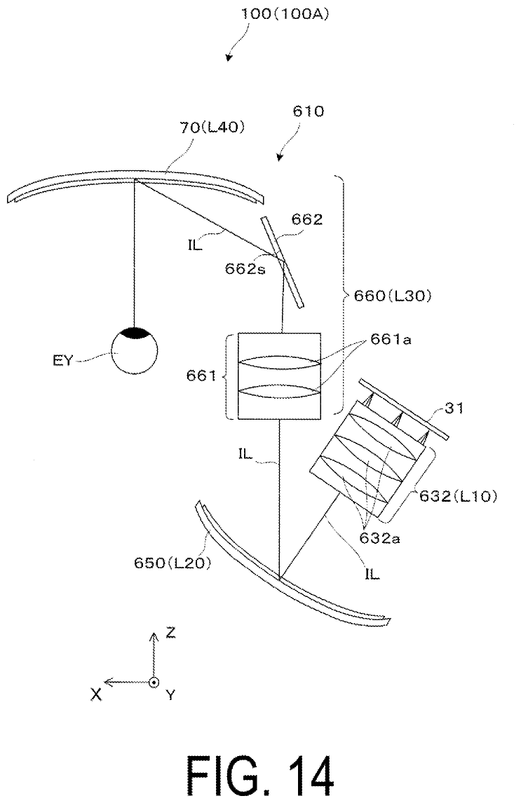

FIG. 14 is a ray diagram of an optical system in an HMD according to another example, and FIG. 14 corresponds to FIG. 2. In the same manner as the case of the optical system 10 illustrated in FIG. 2, an optical system 610 illustrated in FIG. 14 includes, in addition to an image light generating device 31, a first optical part L10 having a positive power, a second optical part L20 having a positive power, a third optical part L30 having a positive power, and a fourth optical part L40 having a positive power. The first optical part L10 is constituted of a projection optical system 632, the second optical part L20 is constituted of a first diffractive optical member 650 that is a reflection-type diffraction element, the third optical part L30 is constituted of a light guiding system 660, and the fourth optical part L40 is constituted of a second diffractive optical member 670 that is a reflection-type diffraction element. Light incident surfaces of the first and second diffractive optical members 650, 670 each have a center portion thereof recessed with respect to a peripheral portion thereof thus being formed in a curved shape, and can efficiently deflect an incident light toward the light guiding system 660.

The projection optical system 632 is an optical system configured to project an image light IL generated by the image light generating device 31, and is constituted of a plurality of lenses 632a. In FIG. 14, a case where three lenses 632a are provided in the projection optical system 32 is described as an example. However, the number of lenses 632a is not limited to such an example, and the projection optical system 632 may include four or more lenses 632a. Further, the projection optical system 632 may be formed by bonding the respective lenses 632a to each other. Further, the lens 632a may be formed of a free-form lens.

The light guiding system 660 includes a lens system 661 on which an image light IL emitted from the first diffractive optical member 650 is incident, and a mirror 662 that emits the image light IL emitted from the lens system 661 in an obliquely inclined direction. The lens system 661 is constituted of a plurality of lenses 661a. The mirror 662 includes a reflective surface 662s that is obliquely inclined with respect to a fore and aft direction. Although the mirror 662 may be a total reflection mirror, to widen an external light visible range, a half mirror may be used as the mirror 662.

Also in the configuration as described above, a diffractive optical member 300 having the above-mentioned structure is used as the first diffractive optical member 650 and the second diffractive optical member 670 and hence, favorable image formation can be realized.

With respect to the respective embodiments described above, various combinations are conceivable. For example, when a plurality of diffractive optical members are provided in the HMD, the diffractive optical members having different configurations may be used in combination. Further, it is also possible to apply the water repellent layer 460 as the buffer layer BL illustrated in the second embodiment may be adopted instead of the resin layer 360 in other embodiments.

Further, in the display device 100 and the like illustrated in FIG. 1, an image light IL is guided in the horizontal direction (a direction parallel to an XZ plane) as a main direction. However, the present embodiment is not limited to such a configuration, and the present embodiment is also applicable to a case where the image light IL is guided in a vertical direction (a direction parallel to a YZ plane) as a main direction, for example.

For example, in the respective embodiments described above, although the display device 100 is incorporated into the HMD 200, the display device 100 can be also incorporated into a head-up display.

Further, the diffractive optical members 300 illustrated in the respective embodiments described above may also be applicable to various optical components or various products that use a diffractive optical member other than the HMD or the like.

Further, although various modes are conceivable with respect to water vapor permeability of the first dielectric film 331, the second dielectric film 332, and the third dielectric film 333, it is preferred that the water vapor permeability be set to a value ranging from 0.1 g/m²·0.24 hr (40° C., 90% RH) to 2.0 g/m²·0.24 hr (40° C., 90% RH) inclusive, for example, and more preferably be set to a value ranging from 0.1 g/m²·0.24 hr (40° C., 90% RH) to 1.0 g/m²·0.24 hr (40° C., 90% RH) inclusive. With this, a function as a water vapor barrier layer for suppressing or preventing the entry of moisture (water vapor) into the hologram element 310 can securely be exerted.

The display device 100 or the HMD 200 is not limited to a see-through type device that a user (wearer) can observe an image of an outside world in a see-through manner, and is also applicable to a closed type HMD that blocks an image of an outside world. In this case, for example, out of the first substrate 321 and the second substrate 322 illustrated in FIG. 3 and the like, one substrate that does not allow the image light IL to pass therethrough may be formed of a material having no light transmissivity (an opaque material). Further, on a side where the substrate is formed of an opaque material, besides the material for forming the substrate, also with respect to a material for forming the dielectric film, a material having no transparency can be used.

As has been described heretofore, the first diffractive optical member according to one specific aspect of the present disclosure includes: the hologram element, the substrate that supports the hologram element, the dielectric film that is provided between the hologram element and the substrate, the buffer layer that is formed around the hologram element and buffers a stress applied to the hologram element from outside of the hologram element, and the adhesive layer that makes the buffer layer and the dielectric film adhere to each other.

According to the above-mentioned diffractive optical member, it is possible to avoid or suppress that the diffraction in the hologram element is adversely influenced by a stress caused by curing and contraction accompanying the formation of the adhesive layer and, further, by providing the dielectric film, it is possible to suppress or prevent the intrusion of moisture into the hologram element with certainty. For example, when the diffractive optical member is applied to the virtual image display device, favorable image formation can be realized.

In a particular aspect, the buffer layer is the low elastic modulus resin layer formed of a material having the lower elastic modulus than the member forming the surface of the hologram element. In this case, due to the provision of the buffer layer, a stress (typically, a stress caused by contraction accompanying the formation of the adhesive layer) from outside of the hologram layer is minimally applied to the hologram element.

In another aspect, the elastic modulus of the low elastic modulus resin layer is equal to or less than 50 MPa. In this case, the buffer layer is easily deformable to an extent that the buffer layer can sufficiently buffer a stress.

In further another aspect, the low elastic modulus resin layer is formed of an ultraviolet curing resin. In this case, after the ultraviolet curing resin is applied by coating to the hologram element, by irradiating the ultraviolet curing resin with ultraviolet rays, the low elastic modulus resin layer can be formed.

In still further another aspect, the buffer layer is the water repellent layer. In this case, the buffer layer can buffer a stress applied to the hologram element from outside of the hologram element by making use of water repellency.

In another aspect, the water repellent layer is formed of a fluorine-based material. In this case, it is possible to more efficiently utilize an effect of the water repellency.

In further another aspect, the water repellent layer contains a fluorine-based silane coupling agent as a constituent material. In this case, it is possible to form the water repellent layer having the desired water repellency with certainty.

In still further another aspect, the substrate has light transmissivity. In this case, the substrate allows an image light, an external light, or the like to pass therethrough.

In another aspect, the hologram element includes the hologram layer at which interference fringes are formed, and the transparent film layer that forms the surface of the hologram element while protecting the hologram layer, wherein the hologram layer is disposed facing the dielectric film, and the transparent film layer is disposed facing the dielectric film with the hologram layer interposed therebetween. In this case, it is possible to protect the hologram layer by the transparent film layer and the dielectric film with certainty.

In further another aspect, the buffer layer is provided so as to surround the hologram element that is formed by the hologram layer and the transparent film layer in layers when viewed in the normal direction of a cross section across each component. In this case, the hologram element is in a state where the entire hologram element is covered by the buffer layer and hence, it is possible to avoid the hologram element from being influenced by a stress with more certainty.

In still further another aspect, the substrate includes the first substrate and the second substrate that sandwich the hologram element therebetween, the dielectric film includes the first dielectric film provided between the hologram element and the first substrate, and the second dielectric film provided between the hologram element and the second substrate, and the adhesive layer makes the first dielectric film and the second dielectric film adhere to each other. In this case, the hologram element can be fixed by the adhesive layer in a state where the hologram element is sandwiched between the dielectric films provided on the substrates respectively.

In another aspect, the dielectric film includes the third dielectric film provided on the side surface of the hologram element, and the buffer layer is provided on at least three or more surfaces of the hologram element as viewed in cross sectional view taken along a cross section across each component, and the buffer layer is disposed facing the first dielectric film, the second dielectric film, and the third dielectric film.

In further another aspect, the diffractive optical member includes the outer surface dielectric film provided on an outer surface of the substrate. In this case, due to the outer surface dielectric film, it is possible to further suppress or prevent the intrusion of moisture into the hologram element.

In still further another aspect, the diffractive optical member includes the hard coat layer provided on the inner surface of the outer surface dielectric film. In this case, the impact resistance of the diffractive optical member can be enhanced.

Further, the second diffractive optical member according to one specific aspect of the present disclosure includes: the hologram element, the substrate that supports the hologram element, the dielectric film provided between the hologram element and the substrate, and the low elastic modulus adhesive layer formed of a material having the lower elastic modulus than the member forming the surface of the hologram element and adhering the hologram element and the dielectric film to each other.

In the diffractive optical member described above, by adopting the low elastic modulus adhesive layer as the adhesive layer that makes the hologram element and the dielectric film adhere to each other, the influence of a stress generated upon curing and contraction accompanying the formation of the adhesive layer, on the hologram element, can be sufficiently reduced. Accordingly, it is possible to avoid or suppress the influence of the stress on the diffraction in the hologram element, and due to the dielectric film, it is possible to accurately suppress or prevent the intrusion of moisture into the hologram element, and when the diffractive optical member is applied to the virtual image display device, for example, favorable image formation can be realized.

In a specific aspect, the diffractive optical member includes the gap member contained in the low elastic modulus adhesive layer. In this case, it is possible to avoid that the hologram element is pressed and collapsed together with the low elastic modulus adhesive layer that is easily deformed by a stress or the like from outside of the hologram element.

What is claimed is:

1. A diffractive optical member comprising:
a hologram element;
a substrate that supports the hologram element;
a dielectric film that is provided between the hologram element and the substrate;
a buffer layer that is formed around the hologram element so as to buffer a stress applied to the hologram element from outside of the hologram element; and
an adhesive layer that makes the buffer layer and the dielectric film adhere to each other.

2. The diffractive optical member according to claim 1, wherein the buffer layer is a low elastic modulus resin layer that is formed of a material having a lower elastic modulus than a member that forms a surface of the hologram element.

3. The diffractive optical member according to claim 2, wherein the elastic modulus of the low elastic modulus resin layer is equal to or less than 50 MPa.

4. The diffractive optical member according to claim 2, wherein the low elastic modulus resin layer is formed of an ultraviolet curing resin.

5. The diffractive optical member according to claim 1, wherein the buffer layer is a water repellent layer.

6. The diffractive optical member according to claim 5, wherein the water repellent layer is formed of a fluorine-based material.

7. The diffractive optical member according to claim 6, wherein the water repellent layer includes a fluorine-based silane coupling agent as a constituent material.

8. The diffractive optical member according to claim 1, wherein the substrate has light transmissivity.

9. The diffractive optical member according to claim 1, wherein
the hologram element includes a hologram layer at which an interference fringe is formed, and a transparent film layer that forms a surface of the hologram element while protecting the hologram layer,
the hologram layer is disposed facing the dielectric film, and
the transparent film layer is disposed facing the dielectric film with the hologram layer interposed therebetween.

10. The diffractive optical member according to claim 9, wherein
the buffer layer is provided so as to surround the hologram element that is formed in layers by the hologram layer and the transparent film layer when the buffer layer is viewed in a normal direction of a cross section across each component.

11. The diffractive optical member according to claim 1, wherein
the substrate includes a first substrate and a second substrate that sandwich the hologram element therebetween,
the dielectric film includes a first dielectric film provided between the hologram element and the first substrate, and a second dielectric film provided between the hologram element and the second substrate, and
the adhesive layer makes the first dielectric film and the second dielectric film adhere to each other.

12. The diffractive optical member according to claim 11, wherein
the dielectric film includes a third dielectric film provided at a side surface of the hologram element, and
the buffer layer is provided at least three or more surfaces of the hologram element as viewed in cross sectional view taken along a cross section across each component, and is disposed facing the first dielectric film, the second dielectric film, and the third dielectric film.

13. The diffractive optical member according to claim 1, further comprising an outer surface dielectric film provided at an outer surface of the substrate.

14. The diffractive optical member according to claim 13, further comprising a hard coat layer provided at an inner surface of the outer surface dielectric film.

15. A diffractive optical member comprising:
a hologram element;
a substrate that supports the hologram element;
a dielectric film that is provided between the hologram element and the substrate; and
a low elastic modulus adhesive layer that is formed of a material having a lower elastic modulus than a member that forms a surface of the hologram element, and makes the hologram element and the dielectric film adhere to each other.

16. The diffractive optical member according to claim 15, further comprising a gap member is included in the low elastic modulus adhesive layer.

17. A virtual image display device comprising the diffractive optical member according to claim 1.
